(19) United States
(12) Patent Application Publication
(10) Pub. No.: US 2011/0267637 A1
(43) Pub. Date: Nov. 3, 2011

(54) AUTOMATIC REGISTER CONTROL SYSTEM WITH INTELLIGENT OPTICAL SENSOR AND DRY PRESETTING FACILITY

(75) Inventor: Amit Oza, Pune (IN)

(73) Assignee: ECOAXIS SYSTEMS PVT. LTD., Pune (IN)

(21) Appl. No.: 13/144,805

(22) PCT Filed: Oct. 27, 2009
(86) PCT No.: PCT/IN2009/000609

§ 371 Date: Jul. 15, 2011

(30) Foreign Application Priority Data
Jan. 16, 2009 (IN) 105/MUM/2009

(51) Int. Cl. G06K 15/00

(52) U.S. Cl. 358/1.14

(57) ABSTRACT

A print processing system for introducing dry register presetting among a plurality of print stations prior to mounting web on the printing device in all conditions before starting a print job; and also automatically controlling print registration using intelligent sensor(s) for minimizing disturbances caused due to transmission losses and distortion in transfer of analog signals. The intelligent sensor is capable of detecting and evaluating the register errors as well as initiating the correction commands in response to self-evaluated register errors. The print processing system is capable of comprehensively compiling, monitoring and displaying the real-time data including all the local machine parameters, print misregistration values and the performance for each printing station. The method of achieving dry presetting and controlling the print misregistration is also provided.

### FIELD OF THE INVENTION

The present invention generally relates to a system for controlling print misregistration among different colors of an image while being printed on a web. The invention particularly relates to a decentralized system comprising a print register control system used with an intelligent sensor and a dry presetting facility for efficiently controlling the print misregistration and thereby significantly minimizing the printing losses. Accordingly, the present invention relates to a method of specifically introducing dry-presetting arrangement before commencement of a print job and thereafter automatically controlling the print misregistration using an intelligent sensor with built-in capabilities to detect and evaluate register errors as well as to generate the corresponding correctional signals. Further, the register control system of the present invention is capable of monitoring, compiling and displaying the real-time information of machine components (machine/process parameters) and their performance, which is highly usable for enhancing the system design and efficacy.

### BACKGROUND OF THE INVENTION

Multi-colour printing machines have been regularly employed for a vast array of commercial activities in printing industry. Printed images comprising multiple colours are used in various articles, such as printed literature (including periodicals, magazines, brochures), packaging means (including boxes, cartons, sachets) etc. where these articles are further made up of different materials. Commercial requirements with regard to the quality and quantity of printed substrate vary from one segment to another and thus it requires different printing machines for fulfilling the varying printing needs. Based on the quantity and quality of printing requirements, the existing printing machines are broadly classified as web offset printing machines, flexographic printing machines, rotogravure printing machines and security printing machines. In high volume and high quality printing, carried out mostly by rotogravure printing machines, in-line flexographic printing machines or label printing machines, the print quality drastically suffers due to various dynamic conditions resulting in poor color registration, and thus the maintenance of print quality is a major concern in the printing industry.

Although there is a complete range of printing machines which are commercially available in different categories, several common features are observed among them. Most commonly, all types of multi-colour printing machines employs multiple printing stations placed one after another while each one printing a different colour of the image. A printing station basically includes a print cylinder and a pressing cylinder between which travels the material to be printed. The print cylinder is either an engraved cylinder or a cylinder equipped with a printing plate reproducing the printing pattern. In such circumstances, in order to have a good quality print of a multiple-colour image, it is necessary that the printing of each colour of the image is accurately superimposed with respect to each other, avoiding overlapping of different colours of the image printed by different printing stations on a continuously running substrate.

This need of having an accurate and precise printing of multiple colours of an image, while carrying out mass printing on any type of substrate (such as paper, polyester, aluminium foil etc.) and with any type of printing machine (such as rotogravure, flexographic, offset etc.) is typically addressed by a “register control system”.

In printing industry terminology, when different colours of an image are properly positioned with respect to each other, they are said to be “in register”. Any deviation from the ideal positioning of any two different colours is referred to as “misregistration”, and the amount of misregistration is referred to as “print registration error” or “print registration offset”. The objective of a register control system is to control misregistration between different colours of an image, which are printed by different printing stations of a printing machine, on a continuously running substrate.

The common approach adopted by the register control systems known in the prior art is to identify and control misregistration by optically scanning . relative positions of the different colours (of the image being printed). The position of a particular colour on a substrate is indicated by way of printing a mark near the edge of the substrate by the respective printing station while printing the actual portion of the image. These marks are known as “register marks”. Register control systems monitor the register marks and calculate the actual distance between the two marks (which reflect positions of the two colours). The ideal positions of the register marks have specific standard distances between them. The register control systems compare the actual distances with the ideal distances, and work out the print registration error. Thus, the print register error is the difference between the actual distance between the two register marks (representing the two colours) (one mark printed by the current printing station and the other mark printed by a previous printing station) and the ideal/theoretical/standard distance between the same.

Once the error is worked out, the register control system would send out signals for correcting the error. For an image with more than two colours, the same process is adopted at each subsequent printing station. For example, for a 5-colour image, the process would take place at the second printing station (distances between the first and the second colour considered), then at the third printing station (distances between the second and the third colour considered), and so on.

For the purpose of recording the position of register marks on a continuously running substrate, the scanning is carried out on the substrate using an optical sensor or a camera. Typically the optical sensor has a light source. When the light is thrown on the substrate, the colour absorbed would be the colour of the substrate. Thus, depending upon the colour of the register mark, the light reflected back would be different. The sensor would also have means of measuring the reflected light, and converting the same into electrical energy. The analogue electrical signals are transported to the central hardware of the typical register control system, where they are analysed and the correctional signals are being generated in response therein. The correctional signals are sent for implementation of the correction mechanism of either the compensating roller assembly or the angular position of printing cylinder for longitudinal errors and to the lateral positioning mechanism of the printing cylinder for lateral correction. Thus, in general, it is required and expected from a printing machine that the print registration is obtained prior to the start of a print job and continues in strict registration state until the completion of the print job. One common objective of the register control system and related new advancements in the technology are directed towards reduction in the amount of waste being generated while attaining the registration during start-up mode and also during the operational mode of a print job.

Primarily, one of the inherent limitations of the prior art is that, in order for a typical register control system to work, it is imperative that the printing machine is made to run at least once. It is required to bring the machine in register mode so as to initiate the automatic tight registration control mechanism of the register control system. This leads to large amounts of wastage and hence such a method is not cost effective. Furthermore, a common problem with the adjustment of the preset is that when there are different print repeats, the web length between the print stations varies accordingly. If this variation is not addressed appropriately while presetting the printing machine, the system will not be in proper registration. As a result thereby, the register control system cannot automatically start bringing the print in tight tolerance. This requires manual intervention by the operator which again generates some additional waste of time and material.

In prior art, several attempts have been made to attain the presetting of printing machine. In all such improvements and advancements, it is observed that the arrangements are not effective and accurate for attaining absolute presetting conditions.

Further, regarding the automatic register error detection by register control systems, one of limitations of the prior art is that when analogue signals are transported to the central hardware (Central Processing Unit, CPU) over long distances, one would need expansion cables for the same, and this would invariably result in transmission losses and distortion of the analogue signal due to insertion of noises. This undesired lapse in time causes difficulty in detecting the position of the mark for colours with very low contrasts. Furthermore, even a minor time gap in error detection and the response generation negatively affects the smooth functioning of the printing job and results in decreased print quality and/or generation of wastage. Thus there has always been a need to synchronize the error calculation and error-correction for a high speed printing press.

Even further, it has been observed in the prior art register control systems that processing of the signals captured by the sensor takes place at CPU located at a distance. In addition to that, the post processing correctional signals are sent for execution by the CPU back to the shafts or compensators which are usually a part of individual print stations, further contributing to the increase in time gap between mark detection by the sensor and actual correction of the corresponding register error.

Still further, since the CPU is located at a distance from the sensor heads and the print stations, the CPU needs to be properly networked with the sensor as well as other components for continuous relay of input signals and analysis. This hinders the re-assembling and replacement of components of the system. Also such a system is not capable of being used with different kinds of printing machines.

Another limitation of the prior art is that all the processing intelligence of the register control systems are functionally designed at one location, which makes the architecture of the system very centralized with demand for very high power intelligence requirement for the central unit. Therefore, any minor malfunction or fault on the part of the CPU may result in the collapse of the whole system.

Another limitation reasonably associated with the above mentioned limitations of the prior art is that most of the register control systems have a centralised architecture that makes upgrading to new technology a huge challenge. Thus, it is often required to discard old hardware while adopting the new technology, thereby resulting in subsequent increase in additional costs for installation of new hardware/software. Since such centralised systems are rigid and non-flexible, it poses a serious limitation in switching from one type of printing machine to another.

Yet another limitation of the prior art is that it does not compile the information on how much material is being printed within the acceptable tolerance limit. Obviously, it does not provide the historical data of a location within a reel where the material printed is beyond the acceptable level of error and also the print station specific data. The prior art also does not provide recording down time and maintenance time of the machine i.e. machine utilisation features.

Still another limitation of the prior art is that it does not continuously monitor the machine related data along with registration related data i.e. the data with which the end user can improve the resource efficiency, save energy and increase productivity and the OEM (Original Equipment Manufacturer) can improve the design of the machine to save energy and make the packaging industry more sustainable.

Further, as in many other industries, it is desirable in the printing industry to simplify the design of equipment used to ensure efficient operation and cost savings. One area where technological advances afford cost savings is in the design of the printing press and print registration equipment.

### Need of the Invention

Accordingly, a need arises for having a system for introducing the dry register presetting (i.e. presetting even before mounting web on the printing device) in all conditions before starting a print job and also automatically controlling misregistration among different colours of an image during print job, where the system should be suitably devised for minimizing the disturbances caused due to transmission losses and distortion in transfer of analog signals. The system should also be able to comprehensively compiling, monitoring and displaying the real-time data including all the local machine parameters and print misregistration values for each printing station.

### OBJECT OF THE INVENTION

Accordingly, the primary object of the present invention is to provide a cost-effective multi-utility system for intelligently controlling print misregistration in order to significantly minimize the printing losses.

In effect thereof, one of the primary objects of the present invention is to provide a precise method for introducing a dry register presetting arrangement among the set of print stations with respect to each other before the start of a print job in order to avoid the wastage of substrate.

Another essential object of the present invention is to provide a system for achieving print accuracy in high speed printing machines by overcoming the limitation of loss of analogue signal and noise generation during transportation.

Still another object of the present invention is to provide a system in accordance with the above objects, whereby the system is a reasonably decentralized one in terms of its functions as well as architecture in order to enable flexibility in switching or upgrading technology as well as to effectively disperse the system intelligence without any loss of primary functions of the machine.

It is also another object of the present invention to provide a register control system which is capable of monitoring, compiling and displaying real-time and station specific information with regard to machine performance and registration error. The system should also be able to respond immediately on the basis of historical data and predefined parameters to recognize momentary errors and determine the machine efficiency in terms of the amount of material printed within the acceptable tolerance limit.

Yet another object of the present invention is to provide a register control system which is further capable of providing relative data for establishing effective correlation between the machine-less process parameters such as pressure and temperature of machine components with the registration offset value.

Yet another object of the present invention is to provide a simple and cost-effective system for controlling misregistration, whereby it is capable of being configured with different modes of printing when used across different type of printing machines.

Other objects, advantages and preferred embodiments of the present invention will be apparent from the following description when read in conjunction with accompanying figures, which are not intended to limit the scope of the present invention, but are incorporated merely for illustrating the present invention.

### Statement of the Invention

Accordingly, a method is provided herein for imparting dry-pre-setting for at least two printing stations of a printing device by bringing the printing stations in register with each other prior to mounting a web on the printing device; the method comprising the steps of determining the length of the print repeat; determining the location of machine components including but not limited to print cylinders, pressure rollers and side rollers with respect to the path of the web during the said print job; calculating the length of path to be traversed by the web between at least two print stations during the said print job; evaluating the correctional value for adjusting the actual web-path length between print stations to be in proportion to said print repeat length; and incorporating the evaluated correctional value to the actual web length to be traversed by the web during the said print job. Provided further herein is an intelligent sensor to be used with a printing device for detection and evaluation of registration errors as well as initiating correction of self-evaluated registration errors during a print job, the sensor comprising at least one sensing means for detecting register marks; a means for processing, comparing and decoding the detection signals for evaluating the register error; and a means for generation of differential correctional signals to individual print stations in response to the registration error. In addition to the above said intelligent sensor, is provided a method of automatically controlling the print misregistration using the intelligent sensor. Still further is provided a print processing system for introducing and maintaining the in-registration mode among a plurality of printing stations on a printing machine, the system comprising a means for achieving the dry presetting as according to the method such as one disclosed herein above; an intelligent sensor such as described herein above; and a register control means operably networked with the sensing means and the printing stations for controlling the response behavior against the received registration errors based on the predefined working parameters of the printing machine, wherein the said print processing system is capable of minimizing the wastage and correctional losses during a printing job.

### BRIEF DESCRIPTION OF THE ACCOMPANYING FIGURES

To assist with understanding of the present invention, references will be made to the accompanying drawings, as described below:

FIG. 1 pertains to the general block diagram of common shaft machines with register control system.

FIG. 2 pertains to an arrangement of web around print cylinder and side rollers, where the web is mounted to pass from outside the side rollers (left & right).

FIG. 3 pertains to an arrangement of web around print cylinder and side rollers, where the web is mounted to pass from inside the left side roller and outside the right side roller.

FIG. 4 illustrates the dry presetting system and method.

FIG. 5 illustrates the internal block diagram of the sensor.

FIG. 6 depicts the internal processing of the signals using an RGB photo detector assembly.

FIG. 7 pertains to a block diagram of a print register control system for printing a multi-colour image upon a web.

### DETAILED DESCRIPTION OF THE INVENTION

It is apparent from the foregoing description of the prior art that the known printing devices and the associated systems for controlling print misregistration are not equipped to provide a means for dry register presetting before the commencement of a new print job and are also not very effective in preventing print losses, especially during high speed printing requirements.

A new method and an intelligent sensor is described herein working in consonance with an advanced register control system as part of a print processing system, which is found to have overcome some or all of the problems associated with the control of print misregistration in the prior art.

However, for the purpose of the present invention, following terms have their below-described respective meanings:

Automatic Mark Recognition (AMR) shall mean and include the state where sensor tries to recognize the position of predefined block marks of predefined height and gap between marks, which is usually, but not limited to, for a 3 block marks of 6 mm, 3 mm and 3 mm height with a gap of 3 mm in between the marks.

‘Gate input’ shall mean and include the signal with effect of which a window of sensing head is opened for doing measurement with specific marks, where the sensor will evaluate the distances and width of the mark present within the window. Gate usually refers to the relation between the window of the encoder position and the actual printed mark being sensed by the sensor.

‘In-register’ mode of the printing machine is the status of the machine in which the printing stations are in accurate synchronization with each other for the purpose of printing a particular print job.

‘Correctional losses’ means and includes the set of losses incurred while making an attempt to rectify the registration errors in a printing machine caused due to momentary changes. The momentary errors are inherent part of every printing set up and the nature of these errors is such that they must ideally be ignored. Any attempt made to correct such errors is bound to cause more errors, whereby a correctional signal so made in response to any such momentary error results in another error in opposite/reverse direction, which will be detected in the second cycle and the system will tend to correct that error. Thus, it takes several cycles for the system to get rid of the error and stabilise. Most of the time, such recurrence of error generation and detection results in a large amount of printing losses, referred to as correctional losses.

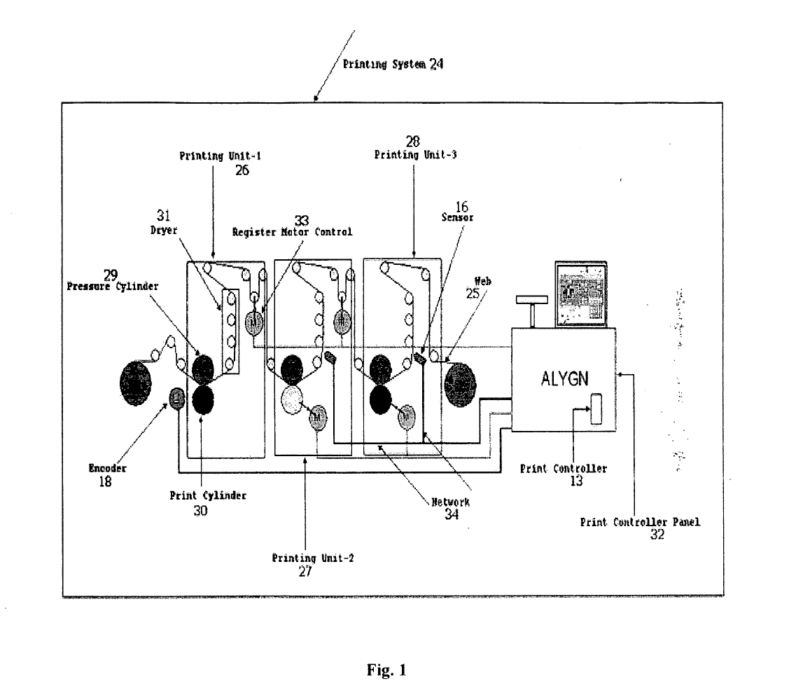

For the purpose of general understanding of the invention, it is hereby disclosed, with the help of FIG. 1, a printing system (24) for printing a multi-color image upon a substrate (25). In this specific embodiment, there are three printing stations/units (26-28); each prints one colour of the image upon the substrate (25). Each printing station (26-28) includes a pressure cylinder (29), a copper engraved printing cylinder (30), and a dryer (31). The system also includes a print controller panel (32), encoder (18) and sensors (16). Print station interface is in terms of register motor control (33), encoder (18) and sensors (16). The interface with sensors is by way of network (34). The sensors are responsible for collection of data regarding placement of register marks on the web in response to which the correctional signals are generated. These correctional signals have the proper (conventional) protocol to precisely control longitudinal and lateral positioning of print from stations (26-28) to moving substrate (25) such that the colors printed by the printing stations (26-28) are registered to produce a multi-color image having suitable quality. This type of printing is commonly referred to as rotogravure printing. However, it may be noted that, the underlying design of rotogravure machines or in-line flexographic printing machines are frequently used in the description part merely for the purpose of facilitating simplified explanation and are certainly not intended to limit the scope of the present invention in any manner whatsoever.

In general, traditional automatic register control systems look at the pre-defined print marks and try to maintain the marks at a predefined relative position. In order to achieve this, the register control systems employ sensors to detect the marks; a central processing unit to calculate the error and sending the correctional signals; and some compensating mechanism for effectuating the correctional signals. However, it is common knowledge that in order for the register control system to work, it is imperative that the printing machine is made to run at least once. It results in generation of large amounts of wastage and hence such a method is certainly not cost effective. Therefore, one of the embodiment of the present invention is to provide a method to achieve the optimal setting of print stations without running the machine even once or mounting the web on the machine (i.e. dry pre-setting), thereby resulting in considerable saving of time and minimizing print wastages. Unlike the register control mechanisms forming the prior art, the dry (register) presetting mechanism allows the printing machine to be ready to print “in-register” even before a print job has been put into operational mode.

The ‘in-register’ mode of the print stations is primarily achieved by adjusting the relative position of print cylinders with respect to each other in order to bring the web path length to be traversed by the web between two print stations in proportion to the calculated print repeat length for the particular job, and usually in some integer multiple of the print repeat length or adjusting the relative angular position of the print cylinder with respect to one another. Traditionally, with the start of every new print job, the print repeat length varies and since the print cylinders are placed randomly and are not in register with each other, the operator has to roughly bring them in register manually. As this is a process which has to be done manually at each station it is usually carried out at low speed. Only after the pre-registration is roughly attained, the register control system can be set to work in automatic mode and bring the print in tight registration. However, it has been observed that, most of the times these print stations of a printing machine do not exhibit a desired degree of registration prior to the start of print job, therefore it is not viable for the operator to confer stringent automatic register control mechanism from the very beginning of the print job, which would otherwise result in heavy print losses. In order to minimize such losses, the prior art adopts a mechanism with a gradual shift from low stringency to high stringency mode of the register control system. Nevertheless, during this transition phase, the machine still generates waste, albeit at a slower pace. Hence one loses the productive time as well as material before the machine starts producing sellable material.

It is also observed by the present inventor that the existing models for achieving dry presetting are not as effective and accurate to allow the printing machines to adopt a stringent mode of automatic register control from the very beginning of a print job.

Accordingly, in light of the present invention, it has been observed that the dry presetting functions can be comfortably and aptly achieved by a controlled process flow for evaluating presetting variables using fixed machine parameters. The calculated process flow causes the longitudinal and the lateral settling units to suitably alter the path length to be traversed by the substrate so that prior registration is accorded in order to achieve and maintain said relative positions of the pressure cylinders in conjunction with the settling units for optimal print performance and pre-error control prior to the initiation of a print job as dry presetting when the print station is in idle mode.

In dry presetting the printing machine as well as register control system is preset such that when the printing is initiated, the printing process is already in tight registration and the register control system runs in automatic mode to continue the tight registration immediately without any loss of time or material. This is achieved by either adjusting the position of the linear compensator in accordance with the fact that for achieving in-register mode the web length between the print stations is usually required to be in integer multiples of the print repeat length for the specific job. This compensation of web length may also be achieved by changing the position of the printing cylinder; adjusting the web length between the print cylinders; or by way of changing the position of the compensating roller in the linear compensator assembly; or by any combination of the above.

With such arrangement, the start-up time and start-up wastages are significantly reduced, thus making the machine much more productive in terms of quality and time. The concept is based on the premise that if the print cylinders are placed in a predefined position such that all print the same print image simultaneously, than the web length between the print stations has to be in some integer multiple of the print repeat length. Alternatively, if in the machine there is no provision for adjustment of web length, the print cylinders will have to be adjusted such that they all print in register. However, the challenge here is that with different print repeats, the web length between the print stations is varying, and if it is not considered while making the preset, it's practically not feasible to bring the print in proper registration, thereby forcing for some manual intervention by the operator which again generates some additional waste of time and material. Therefore, as described, the present invention provides for an accurate method to carry out the very precise configuration for the adjustment of dry presetting of print cylinders in the given printing machine for all the repeat lengths.

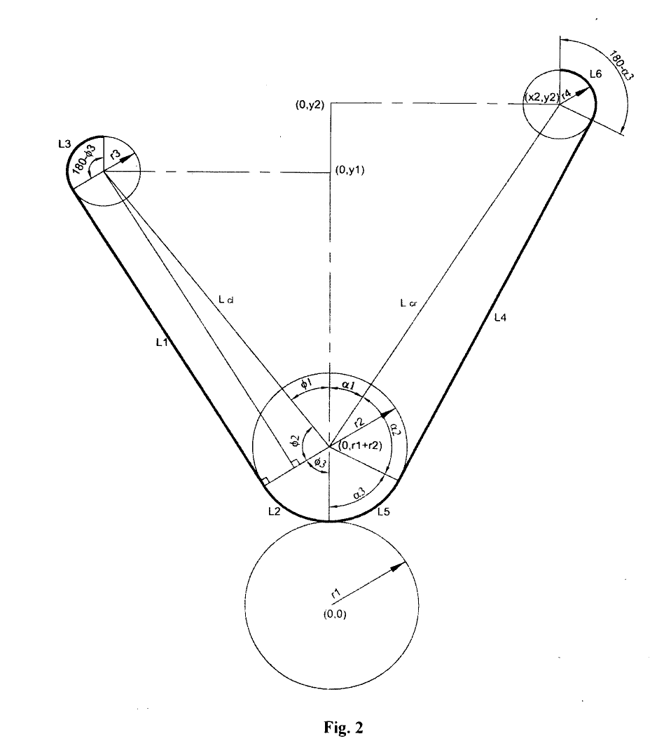

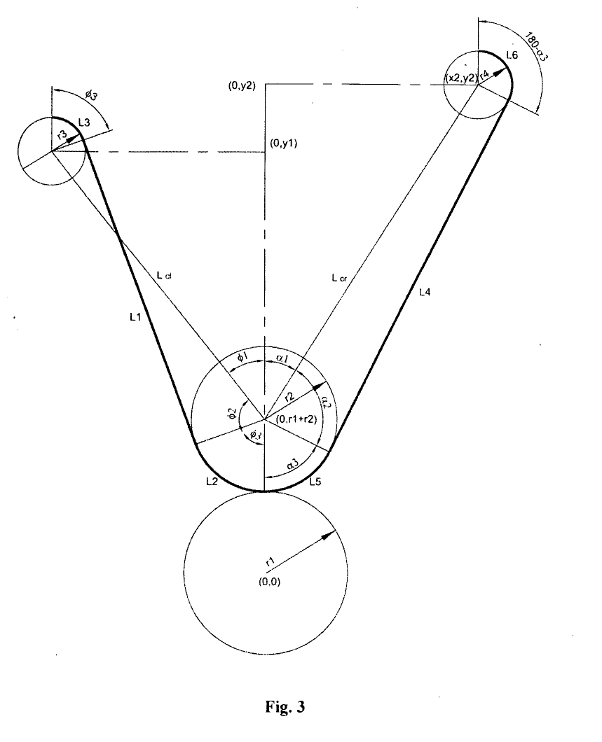

In one of the preferred embodiment of the present invention, calculations are provided for the general machine configuration where the web-length between the print stations varies with the variation in the dimensions of print cylinder & pressure rollers. An accurate calculation for the web-length is carried out in order to have an almost foolproof presetting system. Now, continuing with the basic perception that for a good registration is to be achieved, the web-length between the print stations are required to be in multiple of repeat length, the respective arrangement is shown in FIG. 2 and FIG. 3. According to the figures, total web length is to be calculated in three parts, where we also know the numbers of repeats (N) present in between the print stations. Thus, it is desired to calculate the variable parameters, i.e. the web length between the rollers which are immediately before & after the print stations. Rest of the web length is usually fixed and need not be calculated.

Thus, in accordance with the present invention, one of the preferred embodiment for the method of calculating the web-length is disclosed herein below.

Thus the total variable length according to FIG. 2 and FIG. 3 (Lₜₒₜₐₗ)=L1+L2+L3+L4+L5 +L6

Where, L1 is the length of the web between the tangential points of pressure roller & roller (left) cylinder. L2 is the web-length touching the pressure roller (left side). L3 is the web-length touching the roller (left). L4 is the length of the web between the tangential points of pressure roller & roller (right) cylinder. L5 is the web-length touching the pressure roller (right side). L6 is the web-length touching the roller (right). It is found that the web-length touching the roller (left or right) depends on the exit position which further depends on the web-path beyond this roller & exit would be same always AND tangential position of the web which would vary. Hence it is ascertained that if the web-length is calculated from tangential point to some fixed point (say vertical top) in our variable length, we can deduce the accurate figure for adjustment.

Therefore,

L1=L_{cl}×sin Φ2

L2=π×r2×Φ3/180

L3=π×r3×(180−Φ3)/180 [If web is passing from outside the roller, FIG. 2.]

π×r3×(Φ3)/180 [If web is passing from inside the roller, FIG. 3.]

L4=L_{cr}×sin α2

L5=π×r2×α3/180

L6=π×r4×(180−α3)/180 [If web is passing from outside the roller, FIG. 2. or FIG. 3.]

Where,

L_{cl}=(x1²+(y1−A)²)^{1/2}

L_{cr}=(x2²+(y2−A)²)^{1/2}

Φ1=TAN ⁻¹(x1/(y1−A))

Φ2=COS ⁻¹((r−r3)/L_{cl}) [If web is passing from outside the roller, FIG. 2.]

COS ⁻¹((r2+r3)/L_{cl}) [If web is passing from inside the roller, FIG. 3.]

Φ=180−Φ1−Φ2

Similarly,

α1=TAN ⁻¹(x2/(y2−(r1+r2)))

α2=COS ⁻¹((r2r4)/L_{cr}) [If web is passing from outside the roller, FIG. 2. or FIG. 3.]

α3=180−α1−α2

where the coordinates are as follows:

1) Radius of print cylinder=r1

2) Radius of pressure roller=r2

3) Radius of left roller=r3

4) Radius of right roller=r4

5) Co-ordinate of left roller (Left)=(x1,y1)

6) Co-ordinate of right roller (Right)=(x2,y2)

Therefore, for the setting as depicted in FIG. 2, Total Length would be:

L_{Total}=[L_{cl}×sin Φ2]+[π×2r2×Φ3/180]+[π×r3×(180 −Φ3)/180]+[L_{cr}×sin α2]+[π×r2×α3/180]+[π×r4×(180−α3)/180].

Similarly, for FIG. 3, Total Length would be:

L_{Total}=[L_{cl}×sin Φ2]+[π×r2×Φ3/180]+[π×r3×Φ3/180]+[L_{cr}×sin α2]+[π×r2×α3/180]+[π×r4×(180−α3)/180].

The final calculations for a machine with compensator rollers are as follows: Total variable length T1=Lₜₒₜₐₗ as calculated above.

T2=Fixed length outside the given rollers when compensator is at Nominal position (this could be at zero level or middle of the compensating range.

T3=Variable length due to change in the compensator position.

Therefore, T1+T2+T3 =N ×repeat length.

As T1, T3, N & repeat length is known; T2 is calculated from the data of the master job. For a new job, T1 is calculated, T2 & repeat length is known. Hence T3=N×repeat length−T1−T2 can be easily calculated. Moving the compensator for T3 as calculated, one can expect a good dry presetting for any new job. For e.g. L_{totalg}, Lₜₒₜₐₗₙ are calculated and N is found easily at the good job position and repeat length is also known. We need to find T3_{g} when the machine is printing a particular job in register. T2=N×repeat length−T_{totalg}−T3_{g} Now, for a new job, T2, repeat length and Tₜₒₜₐₗₙ are known. We can find the nearest N & then calculate T3=N×repeat length−Tₜₒₜₐₗₙ−T2. Moving the compensator to this position will do the dry-presetting.

For a machine with smaller compensating range, the calculations are slightly different. For main shaft machines with smaller range of the compensating roller, the above method does not work as the range may not be sufficient to move them by T3 amount. Here we need the machine to be upgraded to make the cylinder adjustment by the auxiliary motor connected to the main shaft.

Here the dry presetting is achieved by moving the relative angular movement of the print cylinders. For the above set of conditions, L3 is known to be zero and L_{totalg} & Lₜₒₜₐₗₙ are calculated as in above defined manner. For a good registration, relative angular movement is also known. Suppose X_{g} is the digitizer position, linear movement L4=X_{g}×repeat length/no. of digitizer pulses repeat length & integer number of repeats are known between the print station. Therefore, L2+L_{totalg}+L4_{g}=N×repeat length. From this L2 which is fixed web length between the print stations can be easily calculated. For the new job, repeat length, Lₜₒₜₐₗₙ & N are known, therefore, L4ₙ=N×repeat length−Lₜₒₜₐₗₙ−L2. Angular displacement between the print station Xₙ=L4ₙ×no. of digitizer pulses/repeat length. By moving the print cylinder by Xₙ digitizer position, we can expect the dry registration.

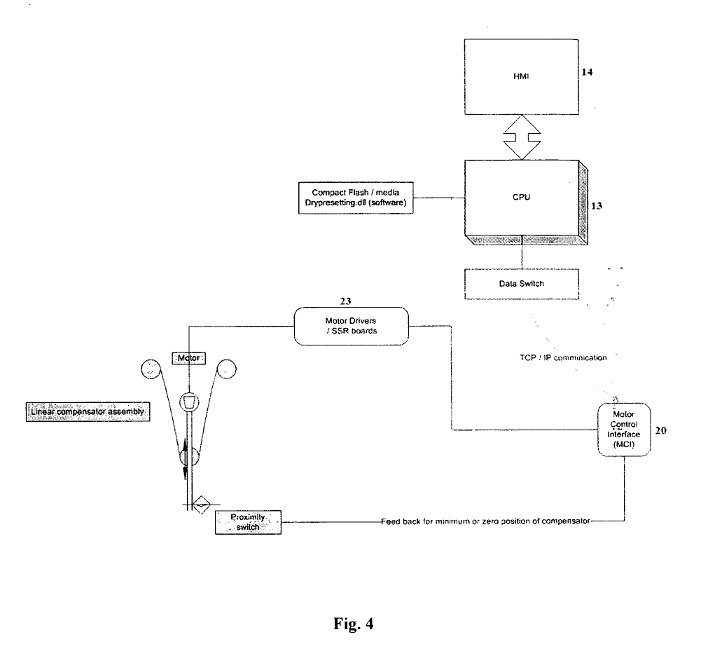

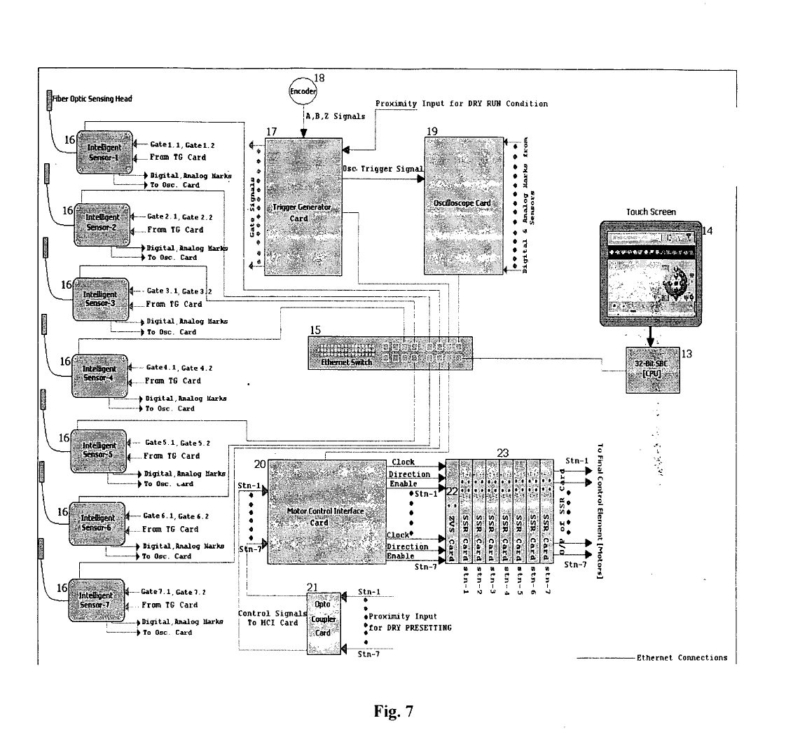

For the purpose of the present invention, the above set of calculations are carried out and duly executed by printing device for every new print job. In one instance, the means for achieving the dry presetting include a processor to implement the steps of calculating the length of the path to be traversed by the web between at least two print stations during the print job and evaluating the correctional value for adjusting the actual web path length between print stations; a means for incorporating the correctional value to the actual web length to be traversed by the web during the print job; and means for communicating the correctional value to the means for incorporating (the means for communicating can include any means for transferring a signal from one system to another system, such as, direct connection, a data transfer interface, a wireless data transfer interface, equivalents and others). In one instance, the processor obtains instructions for implementing the steps from a computer readable medium having the instructions embedded therein. In one of the embodiments of the present invention, as illustrated in FIG. 4, once the precise correctional value is determined by the processor for achieving the dry presetting, the value is sent for display to the operator via graphic user interface (GUI) and subsequently made available to the central processing unit of the register control system for execution. This is achieved either automatically (direct transmission of the calculated value to CPU by communicating means) or by manually feeding the values through graphic user interface, depending upon the machine settings, operator's requirement and the job conditions. From the CPU, the appropriate correction commands are generated in response to received values and are sent to the motor control interface (MCI) for individual printing station. The CPU as used herein includes a processor and computer readable media, the media having instructions embedded therein for the generation of correction commands. Although a variety of equivalent motor control systems, conventional to the motor control art, can be used with the present invention, one of the preferred embodiment is described herein below in FIG. 7, wherein the MCI (20) generates digital signals to drive Solid State Relays (SSR) (23). The SSR card (23) is having SSRs with some digital logic circuit. The output of the SSR cards (23) drives the correction motors connected with the correction mechanism of the printing machine. The Zero Voltage Switch (ZVS) card (22) is used to detect the zero crossover of the supply given to correction motor. The ZVS card (22) generates digital signal on zero cross over signals which is logically “GATED” with motor enable signal coming from the MCI card (20) and given to SSR to ensure motor movement on sufficient voltage level to overcome the inertia of the motor. There is an opto coupler card (21), through which all proximity sensors used in longitudinal and lateral settling units for presetting purpose are connected to the MCI card (20).

In addition to the above, depending on the machine configuration and print job parameters, it may be observed that different type of printing machines may employ different arrangement of the above set of components or their equivalents performing the same or similar functions. However, it has also been observed that, considering the similar thematic workflow of different printing machines, the above objective of achieving the dry presetting can be comfortably accomplished in accordance with the present invention, with incorporation of obvious variation and/or modifications in the calculation described above for the purpose of evaluating correctional values for achieving dry presetting of print stations. Thus effectively, several modifications are possible of the presently disclosed method and corresponding means of obtaining dry presetting, without deviating from the intended scope and spirit of the present invention. Accordingly, in one embodiment, such modifications of the presently disclosed method are included in the scope of present invention.

In this way, the dry presetting is achieved by appropriately incorporating the correctional values, where the CPU itself generates the correctional signals in order to effectuate the pre-print dry presetting conditions. Since, by this time, the web is not yet mounted and the machine is not printing any material, there are no concerns regarding the delay in execution of correction signals due to network based long transmission and time lapse between obtaining the correctional values and executing the corresponding correction in printing device.

Once the dry presetting is achieved and the machine is put in operational mode, the strict registration mode of machine needs to be maintained with the help of sensors and register control system till the print job is complete. Accordingly, as mentioned above, another limitation of the prior art which is addressed by the present invention, is the loss of analogue signals due to transportation over long distance, and ensuing incorrectness in scanning the positions of the register marks. The present invention addresses this problem by obviating the need of the transmission of signals to a great extent. This is accomplished by imparting the capabilities of evaluation of register errors and generation of corresponding correctional signal to the sensor itself, so that the output of the sensor would be in the form of registration error readings and correctional signals, as opposed to mere positions of the register marks or register mark electrical signals (which is the case of a typical register control system forming the prior art). With this intelligence built inside, the sensor need not send mark measurement values or even mark signal to the master controller (the central intelligent unit) via network/expansion cables thus obviating any possibility of transmission losses or distortion of signals due to insertion of noises. The new advanced sensor is an intelligent hardware which not only detects the registration marks and calculates the error based on the reading, but is also capable of processing and performing printing error correction by generating corrective signals to compensators or to motor drives.

In general, the analogue output signal of the receiver/sensor is proportional to the contrast between the colour of the substrate/web and the colour of the print register mark on the substrate/web, as viewed within the viewing footprint of the sensor. To allow for differences in contrast and reflectivity of different substrates, the analogue output signal of the receiver/sensor is suitably gain-controlled. In the present registration detection apparatus, the linear travel of the web gives rise to a sensor signal that varies with time as the registration mark comes into view and then passes the sensor. The analogue output signal is then internally converted into a digital signal and then analyzed by a programmed processor that is part of the intelligent sensor itself. The sensor then locates the actual positions of the register marks printed by the current printing station and a previous printing station, and calculates the distance between them. The sensor then compares the distance with the expected (ideal/theoretical/accurate) distance between the positions of the two register marks, and evaluates the print registration error.

In the presently disclosed print processing system comprising intelligent sensor and advanced register control system with a dry register pre-setting facility, the master controller (CPU) communicates all essential control parameters to the sensors whenever modified & during power on. The sensor generates correction commands/signals based on measured error values and control parameters with all smart algorithms programmed in the sensor. This gives added advantage over other existing systems, i.e. the sensor itself generates correction command immediately after measurement and thus practically there is no delay or communication gap between mark detection and execution of registration error, if any. In this advanced arrangement, the communication of error values to the master controller is performed only for display purposes due to which the control speed and accuracy is significantly improved. This decentralized architecture allows passing on of some part of activity handled by the master controller to the intelligent sensor, making the sensor an adaptive standalone application.

One of the innovative features of the presently disclosed invention is that if the system finds the register error altering/changing so much that in a normal working situation of a typical job cannot happen due to various reasons responsible for the register error, the system comprises of a process flow that it will ignore such error. The reason behind this is that otherwise once such momentary abnormal condition is recognized and acted upon as a genuine error, system will require undergoing some changes again to reverse the correction made earlier. This in turn will generate more wastage called ‘correctional losses’. So if the control logic evaluates that the error change is abnormal, the embodiment of the invention is programmed to ignore the same. The intelligent sensor checks whether the error is due to any momentary changes, and hence needs to be ignored rather than corrected. If the jump error or momentary changes in measured error is found by intelligent sensor then it will generate an error code for jump error and send it for display to the CPU.

The process of the logic control is that if the difference between new measured error and the previous measured error is greater than a set value, then no control command is generated and the system then would display the “Error Blinds” message instead. If the difference is less, then the system would process the new measured error and generate the correction command accordingly.

The amount of error which will be considered abnormal depends on several variable conditions and parameters such as the substrate used for the specific job, the condition of the machine, speed at which the job running etc. So setting of such parameter is left to the judgment of the printing operator. It has been surprisingly found that such abnormal errors can be easily detected by implementing logic in the system whereby every measurement of error is compared with the error measured in the previous cycle. If the difference is greater than the set limit, no correction signal is generated for that cycle. However, irrespective of the decision made this new error observed is stored for comparison for the difference in the next cycle. With the inclusion of such novel feature in the present invention, it is ensured that even if the detected error was genuine, the correction still takes place one measurement later.

According to an embodiment of the present invention, for the purpose of detecting position of the register marks, the sensor has two sensing heads.

Master controller (micro-controller) detects these marks with-in “gate pulse” using optical sensing head assembly. Within this gate signal one of the sensing heads detects the current mark and another sensing head detects the reference mark. The data thus collected by the intelligent sensor is used to calculate and correct error in the marks printed. The sensor calculates the distance between ending edge of gate pulse and rising/falling edge of mark, to calculate the length error and also calculate width of the mark to calculate the side error between marks. Usually, the shape of these register marks are either rectangular or triangular block. With rectangular marks, registration errors along only length of printing are detected whereas with triangular mark, side wise errors are also detected.

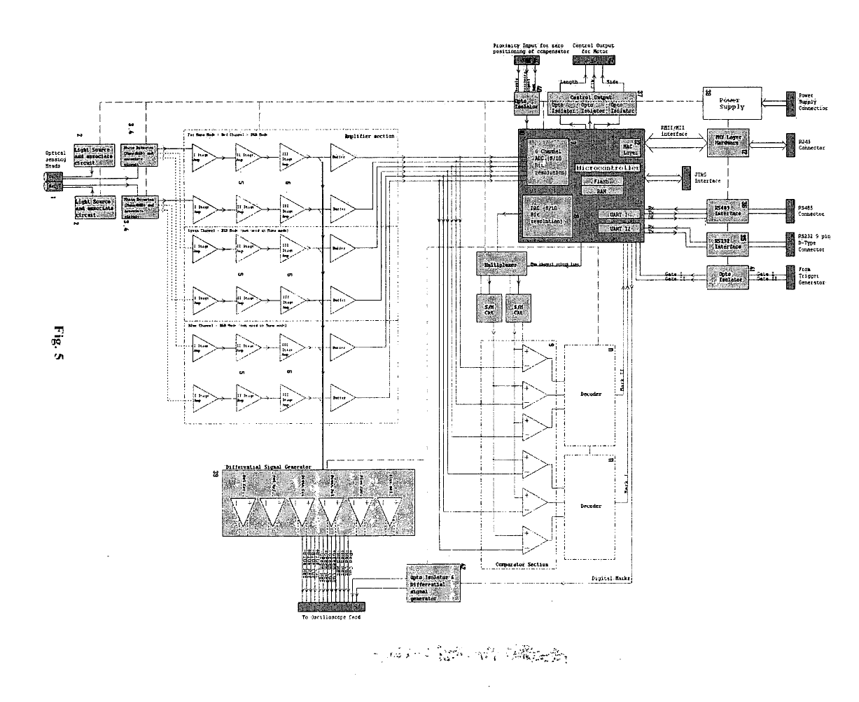

As shown in FIG. 5, which depicts the internal functioning of the sensor in accordance with the present invention, the intelligent sensor primarily has a light source and an associated circuit. The adjoining fiber optic assembly (1) consists of fiber optic cables and sensing heads. The fiber optic cables (1) carry light from the light source (2), generally a powerful white LED, to the substrate on which register marks are printed, and it also carries reflected light captured by the sensing heads from substrate back to the photo detector assembly (4). The sensing heads used could be light based or camera based depending on the use and machine requirements. Thus, the fiber optic cable is basically split into two parts—one part carries light from the light source (2) to the substrate, and the other part carries the light reflected from the substrate to the photo detector assembly (4). At one of the ends of the fiber optic cable all the fiber strands are uniformly gathered across a tiny slit. There is a special lens assembly placed at the end of fiber optic cable, which generates a focused light spot on the substrate. The intelligent sensor also has a provision to have two sensing heads with two sets of above mentioned assemblies (Fiber optic cable (1), Light source (2), photodetector assembly (4), this is mainly useful when the marks are printed laterally instead of circumferentially, Use of two channel sensing head will also give accurate measurement during acceleration and will have less effect of back lash of gears on the measurement. On the other hand, the photo detector assembly can be of two types

1. Monochrome photo detector.

2. RGB photodiode—The photo-diode operates in photo-conductive mode and gives three individual outputs for Red, Green and Blue colors.

The photo detector assembly has good sensitivity for all visible shades making it possible to sense even low contrast marks. The RGB photodiode has internally three independent output currents based on the shade of the colour. The internal intelligence of the sensor allows the selection of the appropriate channel for further processing and that enables better sensitivity over typical monolayer photo detector assembly.

Thus, in one of the preferred embodiment the light reflected from the substrate and carried by the fiber optic cable (1) falls on a three channel RGB photo detector assembly (4), resulting in a change in the reverse current flow in the photo detector assembly. This change is converted into voltage by a photo detector driver circuit (3). For a monochrome detector one signal conditioning circuit is required for current mark and one signal conditioning circuit is required for reference mark. However, for an RGB photo detector six different signal conditioning circuits are required—Red (current and reference signal), Green (current and reference signal), Blue (current and reference signal). Thereafter, the basic function of the sensor is to digitize one of the 3 channel analogue input with respect to gate and it will process the signal having maximum contrast out of three inputs. The gate signal is the one under which the analogue signals of three channels i.e. RGB are to be measured. The voltage output of the driver circuit is provided to a 1^{st} stage amplifier (5). The output of the stage amplifier (5) is provided to a 2^{nd} stage amplifier (6), where the signal is amplified with two different gains, based on the type of the substrate, i.e. for reflective substrate low gain is used and for non reflective substrate high gain is used. This is achieved by using an electronic switch controlled by a microcontroller (10), which is also an internal component of the intelligent sensor.

The output of the second stage amplifier (6) is given to an Analog to Digital Converter (ADC) (7). The ADC is present in the intelligent sensor circuit as an integral part of micro-controller. The ADC is usually a high speed 8/10 bit ADC and the sampling rate of ADC depends upon the cylinder speed. Thus, depending on the gate input given to the microcontroller (10), the microcontroller (10) generates analogue signals using the ADC within the gate and finds out the minimum and the maximum value of the analogue signal and calculates threshold value to generate digital signals out of analogue signal of the register marks. Thus, with the start edge of the gate signal the sensor starts measuring these signals and the ADC circuit starts converting these amplified signals from different channels in to digital values unless it receives gate end edge. All these values are stored in RAM (Random Access Memory) of the system.

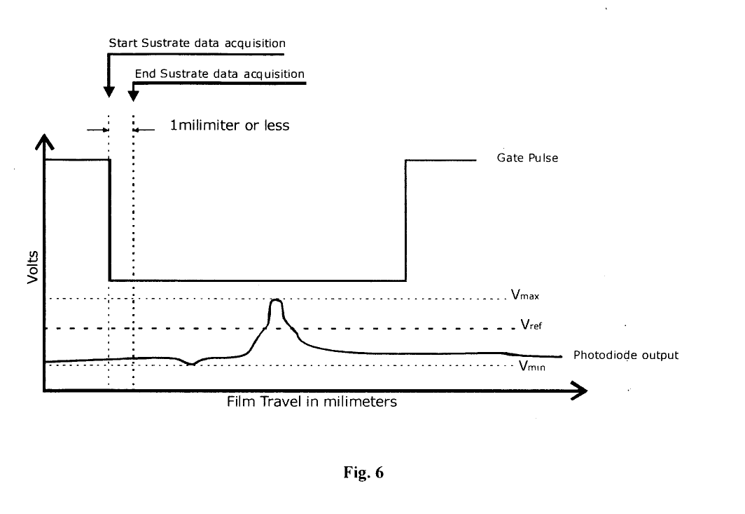

The internal processing of the signals using an RGB photo detector assembly is depicted in FIG. 6. Here, the measured values at the beginning of the gate (say for almost 1 mm) 1 are the R, G, B values of the base material on which the printing is done. Take the value be V_{sub} (subtract voltage). The sensor continuously measures and calculate minimum (Vₘᵢₙ) and maximum (Vₘₐₓ) RGB values till the gate signal is active. If the value of (Vₘₐₓ-Vₘᵢₙ.)/2 for all three channels are less than specified value (e.g. 0.13 volts) then it gives one error code called mark missing signal. But if the (Vₘₐₓ-Vₘₘ.)/2 of any single channel is greater than the specified value then it generates one digitized signal for the channel for which the (Vₘₐₓ-Vₘᵢₙ.)/2 is highest out of 3 channels (the channel with the highest contrast with the base material). Let maximum output be Vmax and minimum output is Vmin. Let difference between Vₘₐₓ and Vₘᵢₙ be V_{diff}. If V_{diff}/2 is greater than V_{sub} then V_{ref} (the reference voltage to be generated from DAC to give it to comparator circuit) is calculated as V_{sub}+(V_{diff}/2). If V_{diff}/2 is less than V_{sub} then V_{ref} is calculated as V_{sub}−(V_{diff}/2).

Consequently, digital threshold value V_{ref} for current mark and reference mark is given to an internal DAC (Digital to Analogue Converter) card (8), which converts the digital threshold value into analogue signal. The DAC is also present in the intelligent sensor circuit as an integral part of micro-controller and the DAC is also an 8/10 bit serial DAC. The converted analogue signal is sent to multiplexer and S/H circuit. The S/H circuit's output then carries analog average signal of different channels to an analogue comparator (9) to compare it with the output of the 2^{nd} stage amplifier(6). The comparator (9) compares the output of the second stage amplifier (6) with the output of the DAC (held by S/H circuit), and generates a digital pulse. The digital pulse (register mark pulse) is carried to the microcontroller (10) through a decoder (11). The microcontroller measures the time between the end of the gate to either of the edges of the digital signal, based on the edge selection information given by the master controller, viz. the CPU (SBC) (13).

Similarly, the time measurement is done for Gate 1 (gate opened for the register mark printed by the current printing station) and for Gate 2 (gate opened for the respective reference mark with the known ideal/expected/theoretically accurate position), and the difference between the time measured for the two gates is calculated. Once the gate signal is deactivated, the sensor stops measurement and deactivates the digital output. Then, based on the circumference of the cylinder (i.e. the repeat size of the print job) and the PPR (pulses per revolution for encoder) information provided by the CPU (SBC) (13) through a LAN card (12), the microcontroller (10) calculates the length error. For side error measurement, the microcontroller (10) measure the time between the digital signal (mark signal) start and end, and using the information provided by the CPU (SBC) (13) through LAN card (12) using the angle of the triangular/wedge mark, it calculates the side error.

The error values are sent to the SBC software to convey correction command to MCI card, for generating corrective signals to compensators in order to correct the error in printing or even sensor can directly generate corrective signals. The communication between SBC and sensor is carried on with the help of Ethernet (TCP/IP). The micro-controller selected has an inbuilt MAC layer which when interfaced with external PHY hardware, makes it possible to establish communication, with the help of TCP stack developed in firmware. The amplified signals after passing through differential signal generator are sent to oscilloscope card along with the digital marks for display. In this way, the intelligent sensor according to the present invention is highly advantageous in comparison to the earlier ones, due to its much more compact structure as it is available with a single board design. Apart from that, it's a highly cost effective and a high speed solution which matches current printing requirements. Finally, the new sensor hardware is relatively very easy to debug, in case of any fault.

In another preferred embodiment of the present invention, the sensor is configured to enable switch selection between amplification in the amplifier circuit dependent upon the type of the substrate/web to be scanned (reflective/non-reflective). The light from the light source is transported to the printed material without much loss of light and the amount of light reflected back from the printed material is converted to the appropriate voltage by the photo-diode. The voltage thereby depends upon the type of material on which the printing is taking place; the color & intensity of the mark being printed; the contrast the ink makes with the material; filter used to filter the amount of light coming back; focusing of the light spot (gets affected with the fluttering of the web); angle at which the light is thrown on the web; and the type of photo-diode being used. These parameters are taken into consideration in order to make sure that the sensor is able to recognize most printing marks irrespective of the contrast they make as well as it recognize the marks on various substrates e.g. paper, aluminum foil, polyester etc. the sensor is also able to calculate the error with high precision and synchronize the error calculation and correction with the web speed.

Further, in accordance with the present invention, a register control system is provided as an essential component of the decentralized architecture of the print processing system. Typically, the register control systems are designed with all the processing intelligence at one location. This in turn makes the architecture of the system very centralized with demand for very high power intelligence requirement for the central unit. According to the present invention, where part of the intelligence being embedded in the sensor itself, the measurement portion gets decentralized from the CPU so that the CPU is free to do more complex functions like management information system much more efficiently and effectively. Allowing the CPU do more operational tasks results in improvement in the overall speed and accuracy of the system. Thus, the system design has decentralized architecture with individual functional units with their individual local intelligence. (for example intelligent sensor, motor control interface, oscilloscope functional block, gate\trigger generator logical unit etc). One of the innovations and advantage of such design architecture is that it has a limited distributed load on each functional block rendering the system faster in processing and execution. And the design is capable to use the same functional blocks for designing various different register control systems as mentioned above without having to redesign a completely new product thereby effectuating reduced costs for installation and maintenance. Thus this unique architecture confers the flexibility of adapting the print processing system or some or all of its components to be configured for rotogravure machines (with mechanical main shaft or electronic line shaft), web offset machines (heat-set or cold set), flexographic printing machines, security printing machines or label printing machines.

In light of the above description, with an enhanced efficacy of the overall system and relatively very low CPU usage for error measurement and correction, the register control system reserves more availability for multitasking and machine monitoring. Accordingly, the register control system of the present invention is capable of compiling, monitoring and displaying real-time and station specific information with regard to registration error on a continuously running basis. The system is also able to respond immediately on the basis of historical data and predefined parameters to recognize momentary errors and determine the machine efficiency in terms of the amount of material printed within the acceptable tolerance limit. Thus, the running information is provided as to how much material is being printed within the acceptable tolerance limit based on the pre-fed machine and print-job specific information. This data is further categorized according to the historical data of a location within a reel where the material printed is with error beyond the acceptable level and also the print station specific data.

Further, in accordance with the present invention, the register control system monitors very effectively and on a continuous basis the machine related data along with registration related data i.e. the data with which the end user can improve the resource efficiency, save energy and increase productivity and thereby the OEM (Original Equipment Manufacturer) can improve the design of the machine to save energy which is highly advantageous in the printing and packaging industry. In continuation with that, it also provides the recording of the down time and the maintenance time of the machine i.e. machine utilisation features for cost saving.

In addition to above, it has also been surprisingly found by the present inventor that several machine-less parameters like temperature, airflow, pressure, air-composition etc. of machine components also tend to make direct impact on the print registration value. Thus, in order to establish the correlation between these parameters and the registration offset value, the register control system of the present invention locally monitors machine/process related parameters like, doctor blade pressure, pressure roller pressure, air temperature of the dryer, airflow of the dryer, solvent concentration in exhaust air, drive/ motor torque. The register control system captures and readily displays all the machine/process related parameter through data logger and sensor and displays it along with corresponding register error. The advantage of this feature is to analyze the effect of machine/process parameters on the registration and assist the operator in considering them while taking either automated, semi-automated or manual actions to improve the overall performance of the machine and system.

The printing system for printing a multi-color image on a web is explicitly illustrated in FIG. 7. The multi-color printing system, embodied herein is described in detail with its specific components and there corresponding features. The CPU (13) of the system comprises of an enhanced graphic user interface (GUI), which is designed for touch-screen based human-machine interface (HMI) (14). The HMI is mainly for use by the operator to feed in machine specific and job specific parameters and also to view the running status of the measured error, performance of the system and machine, speed of the machine and different alarm conditions.

CPU (13) is connected with all the hardware through TCP/IP bus via Ethernet data switch (15). An intelligent optical sensor (16) and a solid state relay (SSR) card (23) serve an individual print station, and are present in the printing machine in multiple numbers based on the total number of print stations. For a print job of an image having X number of colors, X-1 number of intelligent sensors and SSR units are configured. Some hardware like trigger generator (TG) (17), motor control interface (MCI) (20), oscilloscope (19), encoder (18), Zero Voltage Switch (ZVS) card (22) (this ZVS card detects the zero crossover of the line voltage and with reference to pick of line voltage generate motor commands) and opto-coupler card (21) are serve the complete system and are common for all the print stations. The CPU (13) communicates with all the hardware on power-up and establishes connection with all the configured hardware.

An encoder (18) is mechanically connected to the common shaft of the printing machine in such a manner that a single revolution of the encoder (18) is equal to a single revolution of the print cylinder or the print repeat. The encoder (18) generates predefined fix number of pulses per revolution and there is an index pulse or null pulse generation, for every revolution, as reference pulse. Once the print cylinders are loaded on the machine the encoder position for the position of a register mark is fixed, which will not change until the encoder (18) is detached from the machine, or the cylinders are detached from the machine. The encoder (18) is electrically connected with the TG (17). The TG (17) is specially designed hardware using a microprocessor with TCP/IP communication capability. The CPU (13) passes the start and the end gate position of Gate 1 & Gate 2 to the TG (17) at power-on or whenever any gate position is changed. The TG (17) counts the encoder position with respect to index pulse and compares it with the sorted gate position. With help of the counter and comparator the TG (17) generates the gate signals for all the print stations. There are two gates opened by the TG (17) for an individual print station, viz. Gate 1 and Gate 2, which are given to the sensor (16) for error measurement purpose. The TG (17) also calculates the speed of the machine based on the frequency of the index pulse and the circumference of the cylinder provided by the CPU (13).

The CPU (13) also communicates the mode of operation to all the connected intelligent optical sensors (16). It can be either in “Idle” mode, or in “AMR” mode, or in “Error Measurement” mode. The sensors (16) which are connected but not in use are communicated with by the “Idle” mode command; the sensors for which the automatic mark recognition (AMR) search is applied by operator are communicated with AMR mode command and generally all sensors (16) in use are communicated with error measurement command by the CPU (13). In the error measurement mode the CPU (13) passes all required information to the sensors (16) for error measurement. The TG (17) provides the gate signals to the sensor during which the sensor does the sampling of analogue signals and time calculation. Once the gate signals are over, the sensor (16) calculates the length and side error based on the measurement done and information provided by the CPU (13) and communicates the error back to the CPU (13) only for display purpose. The sensor also processes the error for generating correctional command to be finally sent to compensators.

The sensor communicates the correction command to the motor control interface (MCI) (20) for individual printing station. The MCI (20) generates digital signals to drive Solid State Relays (SSR) (23). The SSR card (23) is having SSRs with some digital logic circuit. The output of the SSR cards (23) drives the correction motors connected with the correction mechanism of the printing machine. The ZVS card (22) is used to detect the zero crossover of the supply given to correction motor. The ZVS card (22) generates digital signal on zero cross over signals which is logically “GATED” with motor enable signal coming from the MCI card (20) and given to SSR to ensure motor movement on sufficient voltage level to overcome the inertia of the motor. There is an opto coupler card (21), through which all proximity sensors used in longitudinal and lateral settling units for presetting purpose are connected to the MCI card (20). The MCI card (20) uses those proximity signals also for accomplishing dry presetting and for feedback presetting functions.

The oscilloscope card (19) is used to convert the analogue signals coming from selected sensor (16) to digital data and to send them to the CPU (13) in a packet form for display purpose. Based on the oscilloscope display, operator can set the gate positions manually and it is also useful for diagnostics of the problem.

In the present embodiment of the system architecture many components like TG, MCI, sensor are designed in such a manner that with some incremental development it is possible to utilize the component design originally made for mechanical common shaft machine to other machines like web offset machines, in-line flexographic machines etc. With the system design architecture being decentralized, the transmission of variety of signals or information from one place to another and having them processed at individual functional blocks is significantly reduced. This way the resultant processed information can then be transmitted from one functional block to another through a very high speed network. This innovative feature adapted in the system architecture renders the system hardware very easy to maintain. This results in increasing the reliability of the system as compared to the traditional system architecture.

Further, just like all mechanical system even printing machines are typically required to be operated from zero to their maximum allowable speed.

However the manufacturer of the printing machine has used the components in the machine which safely changes the operating speed at a certain rate. So long as the machine speed change is done within the specified limit, the machine operates under controlled condition. However many times it also left to the operator as to the rate at which they accelerate or decelerate the machine. If this is done faster than the specified limit of the manufacturer, this is bound to create some additional abnormal behavior in the machine which usually results in the malfunction and in turn register variation.

According to another preferred embodiment of the present invention, the print processing system maintains the optimal error control during the acceleration/deceleration of the machine. The register control system logic simultaneously evaluates to control such conditions and if it finds any abnormal operation, the register control system intimates the same to the operator and dynamically controls the machine by suspending the operation momentarily or varying the speed in order to phase out the abnormality with minimal printing losses. By suspending the register correction action during the abnormal condition also in effect result in faster recovery and lower material wastage. As otherwise by the time the acceleration is over and machine is running at normal speed, the register control system would have made some unnecessary correction (due to the wrong operating condition) which the system will have to reverse. Thus by evaluating the abnormal functionality and suspending the correction of register, the system lowers the wastage and achieves optimal control. If current acceleration is greater than the allowable acceleration the system would suspend the correction logic. The system comprises of common components for multiple products, making it adaptable from one application to another more easily and effectively.

The register control system of the present invention comprises multiple functional blocks. The needs of functional blocks are different for different printing machine. For example, rotogravure printing machine requires one sensor and one motor control logic for every printing station. Whereas, for the offset printing machine, there is a need for one sensor per one side of the printing which may include 4 to 6 printing stations. Further, unlike rotogravure printing machine, offset machine may have more than one web running in the printing machine (typical newspaper machine). As the hardware and functional requirements are different for different machines, typically completely independent control systems are found in the prior art. The present invention overcomes this limitation as it is equipped with system architecture with functional blocks. The system can be configured by rearranging the number of functional blocks as per the requirement. This makes the system architecture flexible if the need arises to convert the register control system from one printing machine to another by changing or adding few functional blocks. This feature enables the user to salvage some of the modules of the old architecture while building new functional system as per new requirement and to render the system as customized as possible thus achieving low costs.

It may also be noted that various modifications are possible of the presently disclosed method and systems without deviating from the intended scope and spirit of the present invention. Accordingly, in one embodiment, such modifications of the presently disclosed method, intelligent sensor and print processing system are included in the scope of present invention.

1. An intelligent sensor to be used with a printing device for detection and evaluation of print registration errors as well as initiating correction of self-evaluated registration errors during a print job, the sensor comprising:
a) at least one sensor component for detecting register marks on web:
b) an evaluating subsystem processing, comparing and decoding the detection signals for evaluating register errors; and
c) a signal generating component generating of differential correctional signals in response to self-evaluated registration errors;
wherein the sensor analyzes and evaluates the registration error and generates correctional signals based on the processed registration errors.

2. An intelligent sensor as claimed in claim 1, wherein said at least one sensor component is a light based sensing means.

3. An intelligent sensor as claimed in claim 1 , wherein said at least one sensor component is a camera based sensing means.

4. An intelligent sensor as claimed in claim 2, wherein said light based sensor component comprises:
a) a light source which is preferably a Light Emitting Diode (LED):
b) a transmitting component transmitting the source light and reflected light; and
c) a measuring component measuring the reflected light, preferably a photosensor.

5. (canceled)

6. An intelligent sensor as claimed in claim 4, wherein said transmitting component transmitting the source light and reflected light is a fiber optic cable assembly.

7. An intelligent sensor as claimed in claim 4, wherein said measuring component measuring the reflected light is a wide band relative spectral sensitive photosensor for detecting low contrast marks.

8. An intelligent sensor as claimed in claim 4, wherein the said photosensor is a photodiode and more preferably an RGB photodiode.

9. An intelligent sensor as claimed in claim 1, wherein the said intelligent sensor has a logic control for recognizing registration errors caused due to momentary changes in the printing machine based on the error history and pre-defined machine and job parameters.

10. An intelligent sensor as claimed in claim 1, wherein said sensor automatically adjusts the amplification, factor for light based sensing means depending upon the reflectivity of substrate for printing.

11. An intelligent sensor as claimed in claim 1, wherein said sensor provides for single channel mark to mark measurement, two channel mark to mark measurement and also for mark to cylinder measurement.

12. (canceled)

13. An intelligent sensor as claimed in claim 12, wherein said at least one sensor component detects length as well as side registration offset.

14. An intelligent sensor as claimed in claim 12, wherein said at least one sensor component simultaneously evaluates and processes the length as well as side register errors.

15. A method of automatically controlling the print misregistration, comprising the steps of:
(a) detecting register marks using a single intelligent sensor;
(b) evaluating register errors using the single intelligent sensor; and
(c) generating correctional signals using the single intelligent sensor;
wherein detection of register marks, evaluation of register errors, and generation of correctional signals in response to self-evaluated registration errors is executed by the single intelligent sensor.

16. A method of imparting dry-pre-setting to at least two printing stations of a printing device by bringing the printing stations in-register with each other prior to mounting web on the printing device, the method comprising:
a) determining length of a print repeat;
b) determining location of machine components including but not limited to print cylinders, pressure rollers and side rollers with respect to a path of the web during a print job;
c) calculating a length of path to be traversed by the web between at least two print stations during the print job;
d) evaluating a correctional value for adjusting an actual web-path length between print stations to be in proportion to said print repeat length; and
e) incorporating the evaluated correctional value to the actual web length to be traversed by the web during the print job.

17. A method as claimed in claim 16, wherein the said incorporation is achieved by adjusting an angular position of the compensator or print cylinder; or the length of the web between the print stations; or any combination thereof.

18. A print processing system for introducing and maintaining the in-register mode among a plurality of printing stations on a printing machine, the said system comprising:
a) a means for achieving the dry presetting;
b) an intelligent sensor; and
c) a register control component operatively networked with the intelligent sensor and the printing stations controlling the response behavior against the received registration errors based on predefined working parameters of the printing machine.

19. A method for controlling the print misregistration among a plurality of printing stations on a printing machine, the method comprising:
a) determining a length of print repeat;
b) determining a location of machine components including but not limited to print cylinders, pressure rollers and side rollers with respect to a path of a web during a print job;
c) calculating a length of path to be traversed by the web between at least two print stations during the print job;
d) evaluating a correctional value for adjusting an actual web-path length between print stations to be in proportion to said print repeat length; and
e) incorporating the evaluated correctional value to the actual web length to be traversed by the web during the print job; steps (a) through (e) providing dry presetting;
f) detecting registration marks, after providing dry presetting;
g) evaluating registration errors from the detected registration marks; and
h) correcting the registration errors.

20. A method for controlling the print misregistration among a plurality of printing stations on a printing machine as claimed in claim 19 wherein detection of registration marks, evaluation of the registration errors and the correcting the registration errors by generation of correctional signals in response to the evaluated registration errors is executed by an individual device.

21. A print processing system as claimed in claim 18, wherein said register control component switches a sensing component between a camera based sensor and a light based sensor.

22. A print processing system as claimed in claim 18, wherein the said register control component automatically switches between a key color mode and sequential mode for registration error measurement based on the predefined parameters and preferably based on the operational speed of printing machine.

23. A print processing system as claimed in claim 18, wherein the said register control component further comprises a control logic unit that dynamically changes the control operation momentarily in response to any unforeseen deviation from normal functioning of the system.

24. A print processing system as claimed in any of the claim 18, wherein the said system further comprises a means of comprehensively compiling, monitoring and displaying real-time printing machine parameters including error history, down time and maintenance time.

25. A print processing system as claimed in claim 24, wherein the said means of monitoring real time print data also provides real-time correlation between local process parameters of printing device and corresponding registration offset values, wherein the said process parameters include, but are not limited to, doctor blade pressure; pressure roller pressure; air temperature of the dryer; airflow of the dryer; solvent concentration in exhaust air; and motor torque.

26. A print processing system as claimed in claim 18, wherein any of the components is/are alternatively configurable with printing machines of different configurations preferably rotogravure machines, in-line flexographic machines or label printing machines.

27-29. (canceled)
